(19) United States
(12) Patent Application Publication
(10) Pub. No.: US 2014/0304717 A1
(43) Pub. Date: Oct. 9, 2014

(54) DEVICE AND METHOD FOR PERFORMING PRE-LINKING ACTIVITY PER APPLICATION ACCORDING TO ANDROID APPLICATION EXECUTION REQUEST

(71) Applicant: Seung-Hak Kim, Seoul (KR)

(72) Inventor: Seung-Hak Kim, Seoul (KR)

(73) Assignee: CASTIS CO., LTD., Seoul (KR)

(21) Appl. No.: 14/125,090

(22) PCT Filed: Oct. 11, 2011
(86) PCT No.: PCT/KR2011/007513

§ 371 Date: Jun. 13, 2014

(30) Foreign Application Priority Data
Jun. 10, 2011 (KR) 10-2011-0055987

(51) Int. Cl. G06F 9/54

(52) U.S. Cl. CPC G06F 9/541
USPC 719/320

(57) ABSTRACT

The present invention relates to a device and a method for performing a linking activity between applications for which execution is requested before executing the application, when an application execution request is made on an Android platform, thereby enabling an Android terminal provider to provide an environment for a user to execute the Android application while simultaneously allowing the user to separately perform an activity which is linked to each of the applications before executing the applications.

### TECHNICAL FIELD

The present invention relates to a device and a method for performing a pre-linked activity before executing an application, when an application execution request occurs in the Android platform.

### BACKGROUND ART

Android is a software stack for mobile terminals, which consists of an operating system, middleware and core applications. Android applications operating in the Android platform may be developed by using the JAVA programming language. The Android is mainly used for mobile telecommunication devices. However, the Android are recently used for other devices such as TV, set top boxes, etc.

Korean Patent Application Publication No. 10-2009-0004402 discloses a system for providing a discount on game contents in return for exposure of advertisements during playing a game, which comprises: a user terminal which transmits a user ID and data of the set discount rate to a server, implements a game by loading an execution file and an advertisement control file, and outputs advertisement files via images and sounds at a certain time by controlling advertisement control files; an advertisement server which provides advertisement files to a game contents server and generates signals of game selection; and a game contents providing server which receives a user ID from the user terminals and certifies thereof, manages the user's profile, transmits game execution files to the user terminals by signal exchange with the game contents in the user terminals, controls advertisement output in the game execution files, transmits the advertisement control files monitoring the state of playing games, and transmits the advertisement files to the user terminals by determining whether the pre-set advertisement output conditions are met through communication with the advertisement control files.

The above-mentioned, prior art document is directed to a method for playing a game by certifying a user ID, implementing the game, outputting an advertisement while stopping the game when conditions for outputting the advertisement are met and, then, implementing the game again when conditions for implementing the game are met, which do not output the advertisement during playing the game. In addition, game playing may be interrupted by advertisements during playing the game.

In contrast, according to the present invention, a pre-linked activity may be performed by detecting an Android application execution request before implementing a game. That is, the pre-linked activity is performed before implementing the application and, therefore, the application execution is not interrupted.

Korean Patent No. 10-0831161 discloses a method for intercepting incoming calls which allows for selectively receiving urgent and important calls when it is impossible to receive calls due to meetings and other urgent businesses, comprising: registering an incoming call interception service at home location register; setting a call path through a transmission terminal—an exchanger—an intercepting device—a receiving terminal by controlling a called subscriber and the home location register when the called subscriber receives the incoming call; providing announcement and recording voices by using the intercepting device; and connecting an interactive call path between the transmission terminal and the receiving terminal, according to a call request of the called subscriber during listening to the voices being recorded. According to this prior art document, after intercepting the incoming call, the announcement is provided to the transmission terminal, voice signals being recorded by the caller are provided to the called subscriber and, then, the interactive call path is formed by the request from the receiving terminal.

However, according to the aforementioned prior art document, all the transmission terminal are provided with the same announcement, the receiving terminals are provided with only voice signals, and the incoming call is not transmitted as is intended by the transmission terminal. That is, there are shortcomings that different operations for call requests from each transmission terminal cannot be performed and the call request from the transmission terminal cannot be intactly transmitted. However, according to the present invention, when an application execution is requested, a pre-linked activity may be performed before execution of the application, and the application execution request may be carried out as is requested.

That is, the present inventor has completed the present invention by confirming that an application execution request may be detected and an activity linked to the application may be performed before Zygote carries out a fork process, based on the ideas that all the application are performed through a fork process of Zygote in the Android platform.

### DISCLOSURE

### Technical Problem

The primary object of the present invention is to provide a device for performing a pre-linked activity per an application according to an Android application execution request, comprising: means for detecting generation of the Android application execution request; means for transmitting the Android application execution request; and means for performing the pre-linked activity which is linked to the Android application for which execution is requested before an Android Zygote process carries out an fork process.

Another object of the present invention is to provide a method for performing a pre-linked activity per an application according to an Android, application execution request, comprising: i) defining a pre-linked activity to be performed before carrying out an application when an Android application execution is requested; ii) detecting generation of the Android application execution request; iii) intercepting the Android application execution request; iv) performing the pre-linked activity which is linked to the Android application for which execution is requested before an Android Zygote process carries out an fork process; and v) transmitting the Android application execution request intercepted at the step iii) to at least one selected from the group consisting of Launcher, Activity Manager Service and Zygote process on an Android platform.

### Technical Solution

The above-mentioned primary object of the present invention can be accomplished by providing a device for performing a pre-linked activity per an application according to an Android application execution request, comprising: means for detecting generation of the Android application execution request means for transmitting the Android application execution request; and means for performing the pre-linked activity which is linked to the Android application for which execution is requested before an Android Zygote process carries out an fork process.

The means for detecting detect the application execution request via at least one selected from an application click event of a user, startActivity(Intent) call which a Launcher of an application layer transmits through Binder IPC in an Android software stack or startProcessLocked( ) method which an Activity Manager Service of an application framework layer invokes in the Android software stack, and informs the detected application execution request to the means for transmitting.

In addition, the means for transmitting transmits the informed application execution request to the means for performing when the means for transmitting receives the application execution request detected by the means for detecting.

Moreover, the means for transmitting informs the application execution request informed by the means for detecting of at least one selected from Launcher, Activity Manage Service or Zygote process when the means for transmitting is informed, of the application execution request detected by the means for detecting, or the completion of the pre-linked activity from the means for detecting.

Further, the means for transmitting transmits the informed application execution request to the means for performing when the means for transmitting receives the application execution request detected by the means for detecting.

Additionally, the means for performing defines the pre-linked activity to be performed before carrying out the application based on the application information included in an AndroidManifest.xml file of the application for which execution is requested.

Yet further, the means for performing perform the pre-linked activity defined on the application for which execution is requested and, after completion of the pre-linked activity, informs the means for transmitting thereof.

In addition, the pre-linked activity is to record a time when the application execution is requested, and an information of the application which execution is requested for and stored in the AndroidMenifest.xml file.

Moreover, the pre-linked activity is to select advertisement contents based on the application information stored in the AndroidMenifest.xml file of the application, and to output the selected advertisement contents on a user terminal.

The above-mentioned another object of the present invention can be accomplished by providing a method for performing a pre-linked activity per an application according to an Android application execution request, comprising: i) defining a pre-linked activity to be performed before carrying out an application when an Android application execution is requested; ii) detecting generation of the Android application execution request; iii) intercepting the Android application execution request iv) performing the pre-linked activity which is linked to the Android application for which execution is requested before an Android Zygote process carries out an fork process; and v) transmitting the Android application execution request intercepted at the step iii) to at least one selected from the group consisting of Launcher, Activity Manager Service and Zygote process on an Android platform.

The step i) of the present invention defines the pre-linked activity to be performed before carrying out the application based on the application information included in an AndroidManifest.xml file of the application for which execution is requested.

In addition, the step i) records a time when the application execution is requested, and the information of the application which execution is requested for and stored in the AndroidMenifest.xml file.

Moreover, the step ii) of the present invention detects the application execution request via at least one selected from an application click event of a user, startActivity(Intent) call which a Launcher of an application layer transmits through Binder IPC in an Android software stack or startProcessLocked( ) method which an Activity Manager Service of an application framework layer invokes in the Android software stack.

The step iii) of the present invention commands performance of the pre-linked activity defined at the step i) on the application for which execution is requested after receiving the Android application execution request detected at the step ii).

The step iv) of the present invention performs the pre-linked activity defined at the step i) on the application for which execution is requested, and informs completion of the pre-linked activity.

The step v) of the present invention transmits the Android application execution request detected at the step ii) to at least one selected from the group consisting of Launcher, Activity Manager Service and Zygote process when being informed of completion of the pre-linked activity.

### Advantageous Effects

According to the present invention, an Android terminal provider may provide an environment for performing an Android application, and also allows for carrying out a pre-linked activity before performing the application.

Especially, when the Android terminal provider supplies Android terminals in free of charge, pre-linked activities can be defined and performed before a user implements an Android application in a terminal, in return for the free Android terminal.

In the case of free terminals, the Android terminal provider may implement the activities linked to the application in return for the user's utilization of the application without charge.

Users may obtain free terminals or applications by allowing the pre-linked activities defined by the Android terminal provider to be implemented.

### BRIEF DESCRIPTION OF THE DRAWINGS

FIG. 1 is a schematic diagram of the service according to the present invention.

FIG. 2 is a flow chart illustrating one embodiment of performing a pre-linked activity when an Android application execution is requested.

FIG. 3 is a diagram of the signal flow for performing the pre-linked activity after detecting the Android application execution request, according to one embodiment of the present invention.

FIG. 4 is a diagram of the signal flow for performing the pre-linked activity after detecting the Android application execution request via startActivity(Intent) call, according to one embodiment of the present invention.

FIG. 5 is a diagram of the signal flow for performing the pre-linked activity after detecting the Android application execution request via startProcessLocked( ) method which is invoked by Activity Service Manager, according to one embodiment of the present invention.

### BEST MODE FOR CARRYING OUT THE INVENTION

Hereinafter, the present invention will be described in greater detail with reference to the following examples and drawings. The examples and drawings are given only for illustration of the present invention and not to be limiting the present invention.

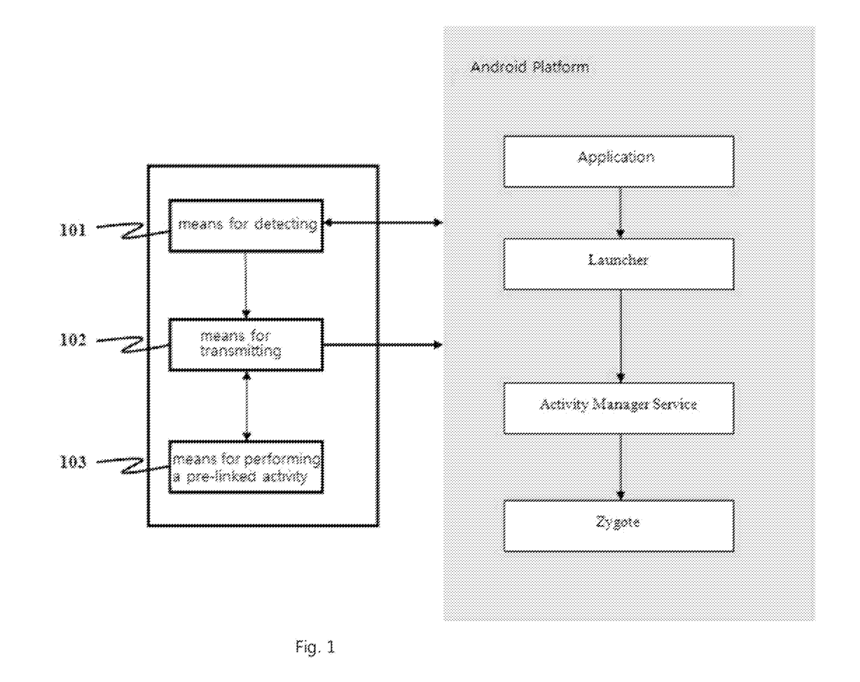

FIG. 1 illustrates a schematic diagram of the service of performing a pre-linked activity in response to an Android application execution request, according to the method of the invention. The service consists of a means for detecting (101), means for transmitting (102) and means for performing a pre-linked activity (103).

The means for detecting (101) detect the application execution request via at least one selected from an application click event of a user, startActivity(Intent) call which a Launcher of an application layer transmits through Binder IPC in an Android software stack or startProcessLocked( ) method which an Activity Manager Service of an application framework layer invokes in the Android software stack, and informs the detected application execution request to the means for transmitting (102).

When the means for transmitting (102) is informed of the application execution request detected by the means for detecting (101), the means for transmitting (102) transmit the informed application execution request to the means for performing the pre-linked activity (103). When the means for transmitting (102) is informed of completion of the pre-linked activity by the means for performing the pre-linked activity (103), the means for transmitting (102) transmit the application execution request to one selected from Launcher, Activity Manager Service or Zygote process.

The means for performing the pre-linked activity (103) define the pre-linked activity which should be implemented before performing the application, based on the application information included in AndroidManifest.xml file of the application for which execution is requested, implement the pre-linked activity defined regarding the application for which execution is requested, and inform the means for transmitting (102) after completion of the pre-linked activity.

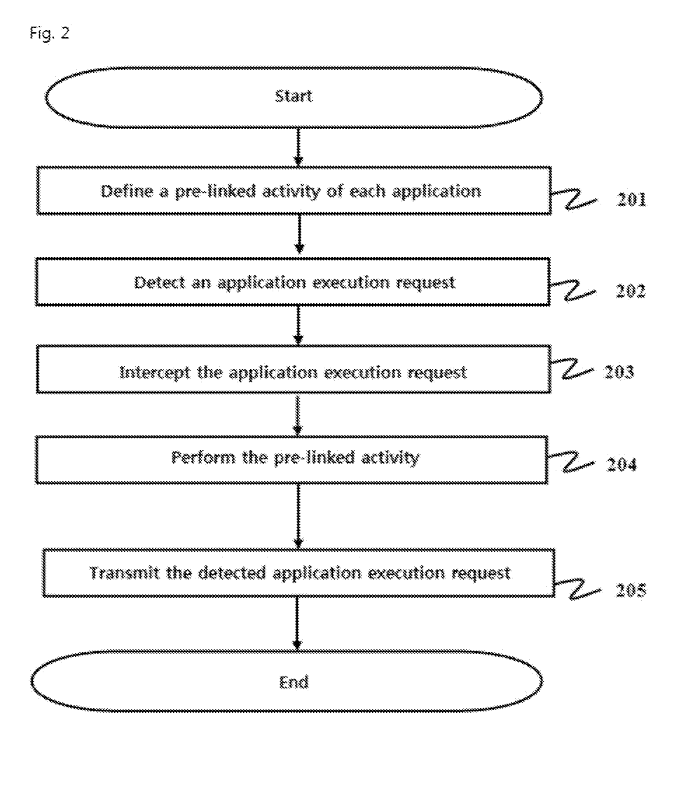

FIG. 2 is a flow chart illustrating one embodiment of performing the pre-linked activity before performing the application, when an Android application execution is requested.

The step 201 is the procedure that defines the pre-linked activity, based on the application information included in the AndroidManifest.xml file of the Android application, which should be performed when the application execution is requested.

The step 202 is the procedure that detects the application execution request via at least one selected from an application click event of a user, startActivity(Intent) call which a Launcher of an application layer transmits through Binder IPC in an Android software stack, or startProcessLocked( ) method which an Activity Manager Service of an application framework layer invokes in the Android software stack.

The step 203 is the procedure that commands the application for which execution is requested, to execute the pre-linked activity defined at the step 201 after receiving the application execution request detected at the step 202.

The step 204 is the procedure that performs the pre-linked activity defined at the step 201 and informs the completion of the pre-linked activity.

The step 205 is the procedure that transmits the Android application execution request detected at the step 202 to at least one selected from Launcher, Activity Manager Service or Zygote process when being informed of completion of the pre-linked activity.

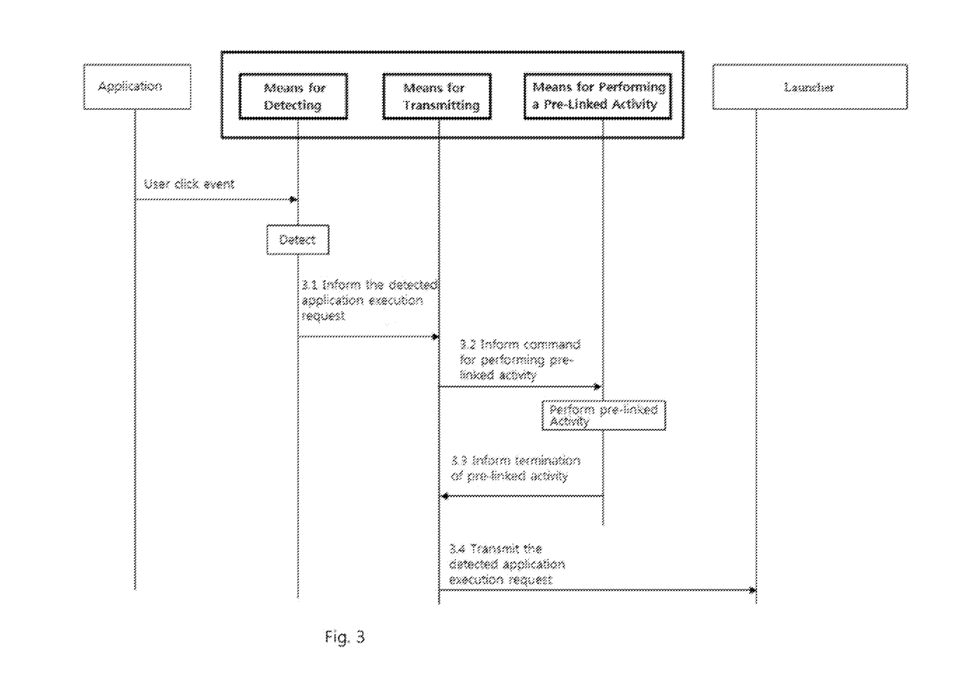

FIG. 3 is a diagram of the signal flow for performing the pre-linked activity after detecting the Android application execution request, according to one embodiment of the present invention.

At the step 3.1, the means for detecting (101) detects the application execution request through a user click event, and informs the means for transmitting (102) the detected application execution request.

At the step 3.2, the means for transmitting (102) commands the means for performing the pre-linked activity (103) to perform the pre-linked activity.

At the step 3.3, the means for performing the pre-linked activity (103) informs the completion of the pre-linked activity after completing the pre-linked activity.

At the step 3.4, the means for transmitting (102) transmits the application execution request detected by the means for detecting (101) to the Launcher of the Android Platform.

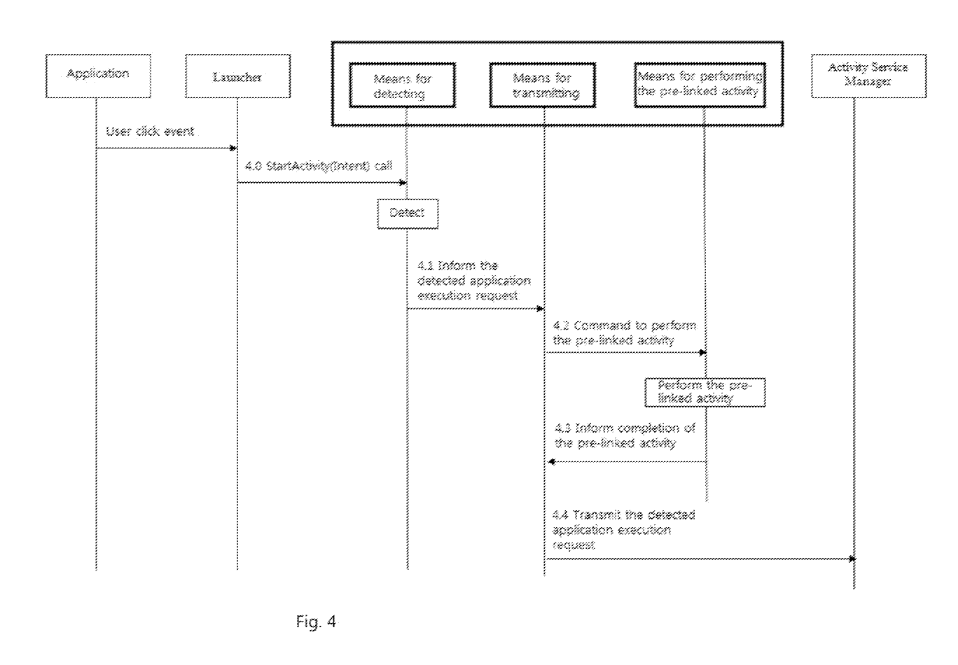

FIG. 4 is a diagram of the signal flow for performing the pre-linked activity after detecting the Android application execution request via startActivity(Intent) call, according to one embodiment of the present invention.

At the step 4.1, the means for detecting (101) detects the application execution request through startActivity(Intent) call, and informs the means for transmitting (102) the detected application execution request.

At the step 4.2, the means for transmitting (102) commands the means for performing the pre-linked activity (103) to perform the pre-linked activity.

At the step 4.3, the means for performing the pre-linked activity (103) informs the completion of the pre-linked activity after completing the pre-linked activity.

At the step 4.4, the means for transmitting (102) transmits the application execution request detected by the means for detecting (101) to the Activity Service Manager of the Android Platform.

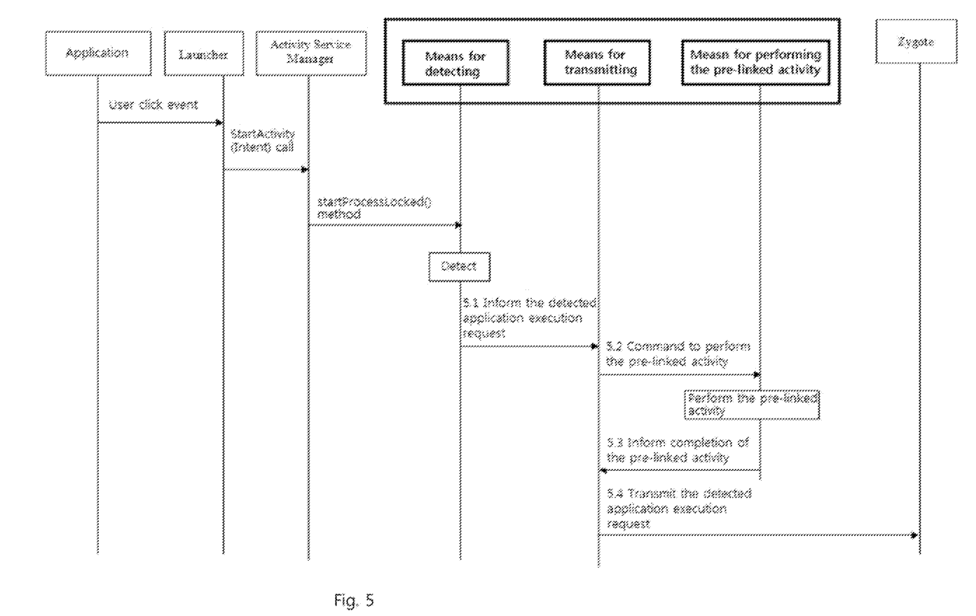

FIG. 5 is a diagram of the signal flow for performing the pre-linked activity after detecting the Android application execution request via startProcessLocked( ) method which is invoked by Activity Service Manager, according to one embodiment of the present invention.

At the step 5.1, the means for detecting (101) detects the application execution request through startProcessLocked( ) method invoked by the Activity Service Manager, and informs the means for transmitting (102) the detected application execution request.

At the step 5.2, the means for transmitting (102) commands the means for performing the pre-linked activity (103) to perform the pre-linked activity.

At the step 5.3, the means for performing the pre-linked activity (103) informs the completion of the pre-linked activity after completing the pre-linked activity.

At the step 5.4, the means for transmitting (102) transmits the application execution request detected by the means for detecting (101) to the Zygote of the Android Platform.

1. A device for performing a pre-linked activity per an application according to an Android application execution request, comprising:
means for detecting generation of the Android application execution request;
means for transmitting the Android application execution request; and
means for performing the pre-linked activity which is linked to the Android application for which execution is requested before an Android Zygote process carries out an fork process.

2. The device of claim 1, wherein the means for detecting detect the application execution request via at least one selected from the group consisting of an application click event of a user, startActivity(Intent) call which a Launcher of an application layer transmits through Binder IPC in an Android software stack and startProcessLocked( ) method which an Activity Manager Service of an application framework layer invokes in the Android software stack, and informs the detected application execution request to the means for transmitting.

3. The device of claim 1, wherein the means for transmitting transmits the informed application execution request to the means for performing when the means for transmitting receives the application execution request detected by the means for detecting.

4. The device of claim 1, wherein the means for transmitting informs the application execution request informed by the means for detecting of at least one selected from the group consisting of Launcher, Activity Manage Service and Zygote process when the means for transmitting is informed of the application execution request detected by the means for detecting, or the completion of the pre-linked activity from the means for detecting.

5. The device of claim 1, wherein the means for performing defines the pre-linked activity to be performed before carrying out the application based on the application information included in an AndroidManifest.xml file of the application for which execution is requested.

6. The device of claim 1, wherein the means for performing perform the pre-linked activity defined on the application for which execution is requested and, after completion of the pre-linked activity, informs the means for transmitting thereof.

7. The device of claim 5, wherein the pre-linked activity is to record a time when the application execution is requested, and an information of the application which execution is requested for and stored in the AndroidMenifest.xml file.

8. The device of claim 5, wherein the pre-linked activity is to select advertisement contents based on the application information stored in the AndroidMenifest.xml file of the application, and to output the selected advertisement contents on a user terminal.

9. A method for performing a pre-linked activity per an application according to an Android application execution request, comprising:
i) defining a pre-linked activity to be performed before carrying out an application when an Android application execution is requested;
ii) detecting generation of the Android application execution request;
iii) intercepting the Android application execution request;
iv) performing the pre-linked activity which is linked to the Android application for which execution is requested before an Android Zygote process carries out an fork process; and
v) transmitting the Android application execution request intercepted at the step iii) to at least one selected from the group consisting of Launcher, Activity Manager Service and Zygote process on an Android platform.

10. The method of claim 9, wherein the step i) defines the pre-linked activity to be performed before carrying out the application based on the application information included in an AndroidManifest.xml file of the application for which execution is requested.

11. The method of claim 9, wherein the step i) records a time when the application execution is requested, and an information of the application which execution is requested for and stored in the AndroidMenifest.xml file.

12. The method of claim 9, wherein the step i) selects advertisement contents based on the application information stored in the AndroidMenifest.xml file of the application, and outputs the selected advertisement contents on a user terminal.

13. The method of claim 9, wherein the step ii) detects the application execution request via at least one selected from the group consisting of an application click event of a user, startActivity(Intent) call which a Launcher of an application layer transmits through Binder IPC in an Android software stack and startProcessLocked( ) method which an Activity Manager Service of an application framework layer invokes in the Android software stack.

14. The method of claim 9, wherein the step iii) commands performance of the pre-linked activity defined at the step i) on the application for which execution is requested after receiving the Android application execution request detected at the step ii).

15. The method of claim 9, wherein the step iv) performs the pre-linked activity defined at the step i) on the application for which execution is requested, and informs completion of the pre-linked activity.

16. The method of claim 9, wherein the step v) transmits the Android application execution request detected at the step ii) to at least one selected from the group consisting of Launcher, Activity Manager Service and Zygote process when being informed of completion of the pre-linked activity.
